(19) United States
(12) Patent Application Publication
(10) Pub. No.: US 2023/0365896 A1
(43) Pub. Date: Nov. 16, 2023

(54) A LAUNDRY TREATMENT FORMULATION

(71) Applicants: Dow Silicones Corporation, Midland, MI (US); Dow Global Technologies LLC, Midland, MI (US); Rohm and Haas Company, Collegeville, PA (US)

(72) Inventors: Saugata Nad, Brussels (BE); Severine Cauvin, Mons (BE); Rahma Benbakoura, Quaregnon (BE); Flore Vandemeulebroucke, Manage (BE); Serge Creutz, Liege (BE); Lyndsay M. Leal, Spring City, PA (US); Emmett M. Partain, III, Bound Brook, NJ (US); Randara Pulukkody, Lansdale, PA (US); Nisaraporn Suthiwangcharoen, Midland, MI (US); Michelle Sikarskie, Midland, MI (US)

(21) Appl. No.: 18/021,718

(22) PCT Filed: Sep. 15, 2021
(86) PCT No.: PCT/US2021/050348

§ 371 Date: Feb. 16, 2023

Related U.S. Application Data
(60) Provisional application No. 63/080,042, filed on Sep. 18, 2020.

(51) Int. Cl. C11D 3/22; C11D 11/00; C11D 3/00

(52) U.S. Cl. CPC C11D 3/227; C11D 11/0017; C11D 3/001

(57) ABSTRACT

A laundry treatment formulation is provided, comprising: a modified carbohydrate polymer, wherein the modified carbohydrate polymer comprises a cellulose ether base material functionalized with (i) trialkyl ammonium moieties of formula (I)

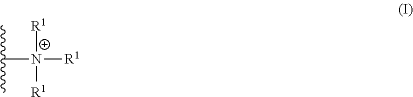

wherein each R¹ is independently selected from the group consisting of a C₁₋₇ alkyl group and wherein the modified carbohydrate polymer has a Kjeldahl nitrogen content, TKN, corrected for ash and volatiles, of 0.75 to 2.5 wt %; and (ii) hydrophobic substituents each having 16 carbon atoms; wherein the modified carbohydrate polymer comprises 0.005 to 1.5 wt %, based on weight of the cellulose ether base material, of the hydrophobic substituents; wherein the hydrophobic substituents are randomly distributed across the backbone of the cellulose ether base material; wherein the cellulose ether base material has a weight average molecular weight, M_{W}, of >800,000 Daltons.

The present invention relates to a unit dose article for treating laundry. In particular, the present invention relates to a laundry treatment formulation comprising: a modified carbohydrate polymer, wherein the modified carbohydrate polymer comprises a cellulose ether base material functionalized with (i) trialkyl ammonium moieties of formula (I)

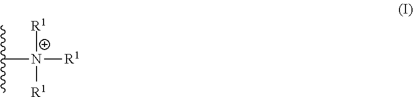

wherein each R¹ is independently selected from the group consisting of a C₁₋₇ alkyl group and wherein the modified carbohydrate polymer has a Kjeldahl nitrogen content, TKN, corrected for ash and volatiles, of 0.75 to 2.5 wt %; and (ii) hydrophobic substituents each having 16 carbon atoms; wherein the modified carbohydrate polymer comprises 0.005 to 1.5 wt %, based on weight of the cellulose ether base material, of the hydrophobic substituents; wherein the hydrophobic substituents are randomly distributed across the backbone of the cellulose ether base material; wherein the cellulose ether base material has a weight average molecular weight, M_{W}, of >800,000 Daltons.

Consumers desire laundry treatment products that provide both cleaning and softening benefits.

There remains a continuing need for laundry treatment agents that impart laundry treatment formulations with cleaning and softening benefits.

The present invention provides a laundry treatment formulation comprising: a modified carbohydrate polymer, wherein the modified carbohydrate polymer comprises a cellulose ether base material functionalized with (i) trialkyl ammonium moieties of formula (I)

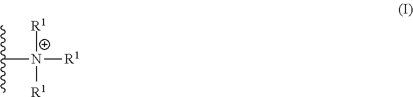

wherein each R¹ is independently selected from the group consisting of a C₁₋₇ alkyl group and wherein the modified carbohydrate polymer has a Kjeldahl nitrogen content, TKN, corrected for ash and volatiles, of 0.75 to 2.5 wt %; and (ii) hydrophobic substituents each having 16 carbon atoms; wherein the modified carbohydrate polymer comprises 0.005 to 1.5 wt %, based on weight of the cellulose ether base material, of the hydrophobic substituents; wherein the hydrophobic substituents are randomly distributed across the backbone of the cellulose ether base material; wherein the cellulose ether base material has a weight average molecular weight, M_{W}, of >800,000 Daltons.

The present invention provides a method of treating a fabric article, comprising: providing a soiled fabric article; providing a laundry treatment formulation of the present invention; providing a wash water; and applying the wash water and the laundry treatment formulation to the soiled fabric to provide a cleaned fabric article.

### DETAILED DESCRIPTION

It has been surprisingly found that laundry treatment formulations comprising a modified carbohydrate polymer of the present invention, alone or in combination with an esterquat provides exceptional cleaning and softness benefits when treating laundry.

Unless otherwise indicated, ratios, percentages, parts, and the like are by weight. Weight percentages (or wt %) in the composition are percentages of dry weight, i.e., excluding any water that may be present in the composition.

As used herein, unless otherwise indicated, the terms “weight average molecular weight” and “M_{w}” are used interchangeably to refer to the weight average molecular weight as measured in a conventional manner with gel permeation chromatography (GPC) and conventional standards, such as polystyrene standards. GPC techniques are discussed in detail in Modern Size Exclusion Liquid Chromatography: Practice of Gel Permeation and Gel Filtration Chromatography, Second Edition, Striegel, et al., John Wiley & Sons, 2009. Weight average molecular weights are reported herein in units of Daltons.

Preferably, the laundry treatment formulation of the present invention, comprises: a modified carbohydrate polymer (preferably, 0.05 to 10 wt % (more preferably, 0.1 to 5 wt %; still more preferably, 0.2 to 3 wt %; most preferably, 0.25 to 2.5 wt %), based on weight of the laundry treatment formulation, of the modified carbohydrate polymer), wherein the modified carbohydrate polymer comprises a cellulose ether base material functionalized with (i) trialkyl ammonium moieties of formula (I)

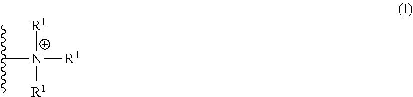

wherein each R¹ is independently selected from the group consisting of a C₁₋₇ alkyl group (preferably, a C₁₋₄ alkyl group; more preferably, a methyl group and an ethyl group; most preferably, a methyl group) and wherein the modified carbohydrate polymer has a Kjeldahl nitrogen content, TKN, corrected for ash and volatiles, of 0.75 to 2.5 wt % (preferably, 0.8 to 2.2 wt %; more preferably, 1.5 to 2.1 wt %; most preferably, 1.7 to 1.8 wt %); and (ii) hydrophobic substituents each having 16 carbon atoms; wherein the modified carbohydrate polymer comprises 0.005 to 1.5 wt % (preferably, 0.1 to 1.1 wt %; more preferably, 0.3 to <0.5 wt %; most preferably, 0.4 to 0.46 wt %), based on weight of the cellulose ether base material, of the hydrophobic substituents; wherein the hydrophobic substituents are randomly distributed across the backbone of the cellulose ether base material; wherein the cellulose ether base material has a weight average molecular weight, M_{W}, of >800,000 Daltons (preferably, 900,000 to 4,000,000 Daltons; more preferably, >1,000,000 to 2,000,000 Daltons; most preferably, 1,200,000 to 1,800,000 Daltons) (preferably, wherein the modified carbohydrate polymer comprises <0.001 wt % (preferably, <0.0001 wt %; more preferably, <0.00001 wt %; most preferably, less than the detectable limit), based on weight of modified carbohydrate polymer, of crosslinking units;) and wherein the water soluble film encapsulates the laundry detergent formulation.

Preferably, the laundry treatment formulation of the present invention comprises a modified carbohydrate polymer. More preferably, the laundry treatment formulation of the present invention comprises 0.05 to 10 wt % (preferably, 0.1 to 5 wt %; more preferably, 0.2 to 3 wt %; most preferably, 0.25 to 2.5 wt %), based on weight of the laundry treatment formulation, of a modified carbohydrate polymer. Most preferably, the laundry treatment formulation of the present invention comprises 0.05 to 10 wt % (preferably, 0.1 to 5 wt %; more preferably, 0.2 to 3 wt %; most preferably, 0.25 to 2.5 wt %), based on weight of the laundry treatment formulation, of a modified carbohydrate polymer; wherein the modified carbohydrate polymer comprises a cellulose ether base material functionalized with (i) trialkyl ammonium moieties of formula (I); wherein each R¹ is independently selected from the group consisting of a C₁₋₇ alkyl group (preferably, a C₁₋₄ alkyl group; more preferably, a methyl group and an ethyl group; most preferably, a methyl group) and wherein the modified carbohydrate polymer has a Kjeldahl nitrogen content, TKN, corrected for ash and volatiles, of 0.75 to 2.5 wt % (preferably, 0.8 to 2.2 wt %; more preferably, 1.5 to 2.1 wt %; most preferably, 1.7 to 1.8 wt %); and (ii) hydrophobic substituents, wherein the hydrophobic substituents comprise an alkyl group having 16 carbon atoms; wherein the modified carbohydrate polymer comprises 0.005 to 1.5 wt % (preferably, 0.1 to 1.1 wt %; more preferably, 0.3 to <0.5 wt %; most preferably, 0.4 to 0.46 wt %), based on weight of the cellulose ether base material, of the hydrophobic substituents; wherein the hydrophobic substituents are randomly distributed across the backbone of the cellulose ether base material; wherein the cellulose ether base material has a weight average molecular weight, M_{W}, of >800,000 Daltons (preferably, 900,000 to 4,000,000 Daltons; more preferably, >1,000,000 to 2,000,000 Daltons; most preferably, 1,200,000 to 1,800,000 Daltons). Preferably, the modified carbohydrate polymer<0.001 wt % (preferably, <0.0001 wt %; more preferably, <0.00001 wt %; most preferably, less than the detectable limit), based on weight of modified carbohydrate polymer, of crosslinking units.

Preferably, the cellulose ether base material has a weight average molecular weight, M_{W}, of >800,000 Daltons (preferably, 900,000 to 4,000,000 Daltons; more preferably, >1,000,000 to 2,000,000 Daltons; most preferably, 1,200,000 to 1,800,000 Daltons). More preferably, the cellulose ether base material has a weight average molecular weight, M_{W}, of >800,000 Daltons (preferably, 900,000 to 4,000,000 Daltons; more preferably, >1,000,000 to 2,000,000 Daltons; most preferably, 1,200,000 to 1,800,000 Daltons); wherein the cellulose ether base material is selected from the group consisting of hydroxyethyl cellulose, hydroxypropyl cellulose, ethyl hydroxyethyl cellulose, methyl cellulose, hydroxypropyl methyl cellulose, hydroxyethyl methyl cellulose and mixtures thereof. Still more preferably, the cellulose ether base material has a weight average molecular weight, M_{W}, of >800,000 Daltons (preferably, 900,000 to 4,000,000 Daltons; more preferably, >1,000,000 to 2,000,000 Daltons; most preferably, 1,200,000 to 1,800,000 Daltons); wherein the cellulose ether base material is selected from the group consisting of hydroxyethyl cellulose, hydroxypropyl cellulose and mixtures thereof. Most preferably, the cellulose ether base material has a weight average molecular weight, M_{W}, of >800,000 Daltons (preferably, 900,000 to 4,000,000 Daltons; more preferably, >1,000,000 to 2,000,000 Daltons; most preferably, 1,200,000 to 1,800,000 Daltons); wherein the cellulose ether base material is hydroxyethyl cellulose.

Preferably, the laundry treatment formulation of the present invention comprises 0.05 to 10 wt % (preferably, 0.1 to 5 wt %; more preferably, 0.2 to 3 wt %; most preferably, 0.25 to 2.5 wt %), based on weight of the laundry treatment formulation, of a modified carbohydrate polymer; wherein the modified carbohydrate polymer comprises a cellulose ether base material functionalized with (i) trialkyl ammonium moieties of formula (I), wherein each R¹ is independently selected from the group consisting of a C₁₋₇ alkyl group (preferably, a C₁₋₄ alkyl group; more preferably, a methyl group and an ethyl group; most preferably, a methyl group) and wherein the modified carbohydrate polymer has a Kjeldahl nitrogen content corrected for ash and volatiles, TKN, of 0.75 to 2.5 wt % (preferably, 0.8 to 2.2 wt %; more preferably, 1.5 to 2.1 wt %; most preferably, 1.7 to 1.8 wt %). More preferably, the laundry treatment formulation of the present invention comprises 0.1 to 5 wt % (preferably, 0.15 to 2 wt %; more preferably, 0.2 to 1 wt %; most preferably, 0.25 to 0.5 wt %), based on weight of the laundry treatment formulation, of a modified carbohydrate polymer; wherein the modified carbohydrate polymer comprises a cellulose ether base material functionalized with (i) trialkyl ammonium moieties of formula (I), wherein each R¹ is independently selected from the group consisting of a C₁₋₇ alkyl group (preferably, a C₁₋₄ alkyl group; more preferably, a methyl group and an ethyl group; most preferably, a methyl group); wherein the modified carbohydrate polymer has a Kjeldahl nitrogen content corrected for ash and volatiles, TKN, of 0.75 to 2.5 wt % (preferably, 0.8 to 2.2 wt %; more preferably, 1.5 to 2.1 wt %; most preferably, 1.7 to 1.8 wt %); and wherein the modified carbohydrate polymer contains <0.1 moles (preferably, <0.01 moles; more preferably, <0.001 moles; most preferably, less than a detectable limit) of trialkyl ammonium moieties having formal (II) per mole of the cellulose ether base material

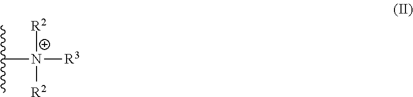

wherein each R² is independently selected from a methyl group and an ethyl group and wherein R³ is selected from a C₈₋₃₀ alkyl group.

Preferably, the laundry treatment formulation of the present invention comprises 0.05 to 10 wt % (preferably, 0.1 to 5 wt %; more preferably, 0.2 to 3 wt %; most preferably, 0.25 to 2.5 wt %), based on weight of the laundry treatment formulation, of a modified carbohydrate polymer; wherein the modified carbohydrate polymer comprises a cellulose ether base material functionalized with (ii) hydrophobic substituents, wherein the hydrophobic substituents comprise an alkyl group having 16 carbon atoms; wherein the modified carbohydrate polymer comprises 0.005 to 1.5 wt % (preferably, 0.1 to 1.1 wt %; more preferably, 0.3 to <0.5 wt %; most preferably, 0.4 to 0.46 wt %), based on weight of the cellulose ether base material, of the hydrophobic substituents. More preferably, the laundry treatment formulation of the present invention, comprises 0.1 to 5 wt % (preferably, 0.15 to 2 wt %; more preferably, 0.2 to 1 wt %; most preferably, 0.25 to 0.5 wt %), based on weight of the laundry treatment formulation, of a modified carbohydrate polymer; wherein the modified carbohydrate polymer comprises a cellulose ether base material functionalized with (ii) hydrophobic substituents, wherein the hydrophobic substituents comprise an alkyl group having 16 carbon atoms bonded to the cellulose ether base material through at least one of an ether linkage (e.g., an ether linkage alone or an ether linkage and a 2-hydroxypropyl group) and an ester linkage; wherein the modified carbohydrate polymer comprises 0.005 to 1.5 wt % (preferably, 0.1 to 1.1 wt %; more preferably, 0.3 to <0.5 wt %; most preferably, 0.4 to 0.46 wt %), based on weight of the cellulose ether base material, of the hydrophobic substituents. Still more preferably, the laundry treatment formulation of the present invention, comprises 0.1 to 5 wt % (preferably, 0.15 to 2 wt %; more preferably, 0.2 to 1 wt %; most preferably, 0.25 to 0.5 wt %), based on weight of the laundry treatment formulation, of a modified carbohydrate polymer; wherein the modified carbohydrate polymer comprises a cellulose ether base material functionalized with (ii) hydrophobic substituents, wherein the hydrophobic substituents comprise an alkyl group having 16 carbon atoms bonded to the water-soluble cellulose ether base material through at least one of an ether linkage (e.g., an ether linkage alone or an ether linkage and a 2-hydroxypropyl group) and an ester linkage; wherein the modified carbohydrate polymer comprises 0.005 to 1.5 wt % (preferably, 0.1 to 1.1 wt %; more preferably, 0.3 to <0.5 wt %; most preferably, 0.4 to 0.46 wt %), based on weight of the cellulose ether base material, of the hydrophobic substituents; and wherein the hydrophobic groups are randomly distributed across the backbone of the cellulose ether base material. Most preferably, the laundry treatment formulation of the present invention, comprises 0.1 to 5 wt % (preferably, 0.15 to 2 wt %; more preferably, 0.2 to 1 wt %; most preferably, 0.25 to 0.5 wt %), based on weight of the laundry treatment formulation, of a modified carbohydrate polymer; wherein the modified carbohydrate polymer comprises a cellulose ether base material functionalized with (ii) hydrophobic substituents, wherein the hydrophobic substituents comprise an alkyl group having 16 carbon atoms bonded to the water-soluble cellulose ether base material through at least one of an ether linkage or an ether linkage and a 2-hydroxypropyl group; wherein the modified carbohydrate polymer comprises 0.005 to 1.5 wt % (preferably, 0.1 to 1.1 wt %; more preferably, 0.3 to <0.5 wt %; most preferably, 0.4 to 0.46 wt %), based on weight of the cellulose ether base material, of the hydrophobic substituents; and wherein the hydrophobic groups are randomly distributed across the backbone of the cellulose ether base material.

Preferably, the modified carbohydrate polymer is of formula (III)

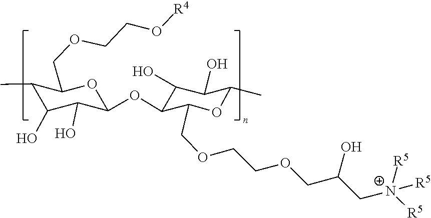

wherein n is determined based on the weight average molecular weight, M_{W}, of the cellulose ether base material; wherein R⁴ is an alkyl group having 16 carbon atoms (preferably, a hydrocarbyl group having 16 carbon atoms; more preferably, a C₁₆H₃₃ group) and wherein each R⁵ is independently selected from the group consisting of a C₁₋₇ alkyl group (preferably, a C₁₋₄ alkyl group; more preferably, a methyl group and an ethyl group; most preferably, a methyl group); and wherein the cellulose ether base material has a weight average molecular weight, M_{W}, of >800,000 Daltons (preferably, 900,000 to 4,000,000 Daltons; more preferably, >1,000,000 to 2,000,000 Daltons; most preferably, 1,200,000 to 1,800,000 Daltons)(preferably, wherein the modified carbohydrate polymer comprises <0.001 wt % (preferably, <0.0001 wt %; more preferably, <0.00001 wt %; most preferably, less than the detectable limit), based on weight of modified carbohydrate polymer, of crosslinking units).

Preferably, the laundry treatment formulation of the present invention, further comprises a liquid carrier. More preferably, the laundry treatment formulation of the present invention comprises 25 to 97.9 wt % (preferably, 50 to 94.5 wt %; more preferably, 62.5 to 91.75 wt %; yet more preferably, 70 to 89.9 wt %; most preferably, 76 to 88 wt %), based on weight of the laundry treatment formulation, of a liquid carrier. Still more preferably, the laundry treatment formulation of the present invention comprises 25 to 97.9 wt % (preferably, 50 to 94.5 wt %; more preferably, 62.5 to 91.75 wt %; yet more preferably, 70 to 89.9 wt %; most preferably, 76 to 88 wt %), based on weight of the laundry treatment formulation, of a liquid carrier; wherein the liquid carrier is selected from the group consisting of water, water miscible liquids and mixtures thereof.

Preferably, the liquid carrier can include water miscible liquids, such as, C₁₋₃ alkanolamines, C₁₋₃ alkanols, C₁₋₃ polyhydric alcohols and mixtures thereof.

Preferably, the laundry treatment formulation of the present invention, optionally, further comprises an additional component selected from the group consisting of at least one of a cleaning surfactant, a structurant, a hydrotrope, a fragrance, a foam control agent (e.g., fatty acid, polydimethylsiloxane, polyalkylarylsiloxane, polyalkylsiloxane); a builder and a fabric softener.

Preferably, the laundry treatment formulation of the present invention, further comprises: a cleaning surfactant; wherein the laundry treatment formulation is a laundry detergent formulation. More preferably, the laundry treatment formulation of the present invention is a laundry detergent formulation, further comprising: 2 to 60 wt % (more preferably, 5 to 40 wt %; still more preferably, 7.5 to 30 wt %; yet more preferably, 10 to 25 wt %; most preferably, 10 to 20 wt %), based on weight of the laundry detergent formulation, of a cleaning surfactant. Still more preferably, the laundry treatment formulation of the present invention is a laundry detergent formulation, further comprising: 2 to 60 wt % (more preferably, 5 to 40 wt %; still more preferably, 7.5 to 30 wt %; yet more preferably, 10 to 25 wt %; most preferably, 10 to 20 wt %), based on weight of the laundry detergent formulation, of a cleaning surfactant; wherein the cleaning surfactant is selected from the group consisting of anionic surfactants, nonionic surfactants, cationic surfactants, amphoteric surfactants and mixtures thereof. Yet still more preferably, the laundry treatment formulation of the present invention is a laundry detergent formulation, further comprising: 2 to 60 wt % (more preferably, 5 to 40 wt %; still more preferably, 7.5 to 30 wt %; yet more preferably, 10 to 25 wt %; most preferably, 10 to 20 wt %), based on weight of the laundry detergent formulation, of a cleaning surfactant; wherein the cleaning surfactant is selected from the group consisting of a mixture including an anionic surfactant and a non-ionic surfactant. Most preferably, the laundry treatment formulation of the present invention is a laundry detergent formulation, further comprising: 2 to 60 wt % (more preferably, 5 to 40 wt %; still more preferably, 7.5 to 30 wt %; yet more preferably, 10 to 25 wt %; most preferably, 10 to 20 wt %), based on weight of the laundry detergent formulation, of a cleaning surfactant; wherein the cleaning surfactant includes a mixture of a linear alkyl benzene sulfonate, a sodium lauryl ethoxysulfate and a nonionic alcohol ethoxylate.

Anionic surfactants include alkyl sulfates, alkyl benzene sulfates, alkyl benzene sulfonic acids, alkyl benzene sulfonates, alkyl polyethoxy sulfates, paraffin sulfonic acids, paraffin sulfonates, olefin sulfonic acids, olefin sulfonates, alpha-sulfocarboxylates, esters of alpha-sulfocarboxylates, alkyl glyceryl ether sulfonic acids, alkyl glyceryl ether sulfonates, sulfates of fatty acids, sulfonates of fatty acids, sulfonates of fatty acid esters, alkyl phenol polyethoxy ether sulfates, 2-acryloxy-alkane-1-sulfonic acid, 2-acryloxy-alkane-1-sulfonate, beta-alkyloxy alkane sulfonic acid, beta-alkyloxy alkane sulfonate, amine oxides and mixtures thereof. Preferred anionic surfactants include C₈₋₂₀ alkyl benzene sulfates, C₈₋₂₀ alkyl benzene sulfonic acid, C₈₋₂₀ alkyl benzene sulfonate, paraffin sulfonic acid, paraffin sulfonate, alpha-olefin sulfonic acid, alpha-olefin sulfonate, amine oxides, sulfonates of fatty acids, sulfonates of fatty acid esters, C₈₋₁₀ alkyl polyethoxy sulfates and mixtures thereof. More preferred anionic surfactants include C₁₂₋₁₆ alkyl benzene sulfonic acid, C₁₂₋₁₆ alkyl benzene sulfonate, C₁₂₋₁₈ paraffin-sulfonic acid, C₁₂₋₁₈ paraffin-sulfonate, C₁₂₋₁₆ alkyl polyethoxy sulfate and mixtures thereof.

Non-ionic surfactants include alkoxylates (e.g., polyglycol ethers, fatty alcohol polyglycol ethers, alkylphenol polyglycol ethers, end group capped polyglycol ethers, mixed ethers, hydroxy mixed ethers, fatty acid polyglycol esters and mixtures thereof. Preferred non-ionic surfactants include fatty alcohol polyglycol ethers. More preferred non-ionic surfactants include secondary alcohol ethoxylates, ethoxylated 2-ethylhexanol, ethoxylated seed oils, butanol caped ethoxylated 2-ethylhexanol and mixtures thereof. Most preferred non-ionic surfactants include secondary alcohol ethoxylates.

Cationic surfactants include quaternary surface active compounds. Preferred cationic surfactants include quaternary surface active compounds having at least one of an ammonium group, a sulfonium group, a phosphonium group, an iodonium group and an arsonium group. More preferred cationic surfactants include at least one of a dialkyldimethylammonium chloride and alkyl dimethyl benzyl ammonium chloride. Still more preferred cationic surfactants include at least one of C₁₆₋₁₈ dialkyldimethylammonium chloride, a C₈₋₁₈ alkyl dimethyl benzyl ammonium chloride and dimethyl ditallow ammonium chloride. Most preferred cationic surfactant includes dimethyl ditallow ammonium chloride.

Amphoteric surfactants include betaines, amine oxides, alkylamidoalkylamines, alkyl-substituted amine oxides, acylated amino acids, derivatives of aliphatic quaternary ammonium compounds and mixtures thereof. Preferred amphoteric surfactants include derivatives of aliphatic quaternary ammonium compounds. More preferred amphoteric surfactants include derivatives of aliphatic quaternary ammonium compounds with a long chain group having 8 to 18 carbon atoms. Still more preferred amphoteric surfactants include C₁₂₋₁₄ alkyldimethylamine oxide, 3-(N,N-dimethyl-N-hexadecyl-ammonio)propane-1-sulfonate, 3-(N,N-dimethyl-N-hexadecylammonio)-2-hydroxypropane-1-sulfonate and cocamidopropyl betaine. Most preferred amphoteric surfactants include cocamidopropyl betaine.

Preferably, the laundry treatment formulation of the present invention is a laundry detergent formulation comprising: 25 to 97.9 wt %, based on weight of the laundry detergent formulation, of a liquid carrier; and, 2 to 60 wt %, based on weight of the laundry detergent formulation, of a cleaning surfactant; and 0.1 to 10 wt %, based on weight of the laundry detergent formulation, of the modified carbohydrate polymer. More preferably, the laundry treatment formulation of the present invention is a laundry detergent formulation comprising: 25 to 97.9 wt %, based on weight of the laundry detergent formulation, of a liquid carrier; and, 2 to 60 wt %, based on weight of the laundry detergent formulation, of a cleaning surfactant; and 0.1 to 10 wt %, based on weight of the laundry detergent formulation, of the modified carbohydrate polymer; wherein the liquid carrier comprises water and wherein >20 wt % (preferably, ≥25 wt %; more preferably, ≥30 wt %; most preferably, >40 wt %), based on weight of the laundry detergent formulation, is water. Most preferably, the laundry treatment formulation of the present invention is a laundry detergent formulation comprising: 25 to 97.9 wt %, based on weight of the laundry detergent formulation, of a liquid carrier; and, 2 to 60 wt %, based on weight of the laundry detergent formulation, of a cleaning surfactant; and 0.1 to 10 wt %, based on weight of the laundry detergent formulation, of the modified carbohydrate polymer; wherein the liquid carrier comprises water; wherein >20 wt % (preferably, >25 wt %; more preferably, >30 wt %; most preferably, >40 wt %), based on weight of the laundry detergent formulation, is water; and wherein the laundry detergent formulation further comprises a mixture of propylene glycol, ethylene glycol monohexyl ether, and glycerin.

Preferably, the laundry treatment formulation of the present invention, further comprises an esterquat. More preferably, the laundry treatment formulation of the present invention, further comprises: 0.1 to 10 wt % (preferably, 0.5 to 8 wt %; more preferably, 1 to 7.5 wt %; most preferably, 2 to 7 wt %), based on weight of the laundry treatment formulation, of an esterquat. Still more preferably, the laundry treatment formulation of the present invention, further comprises: 0.1 to 10 wt % (preferably, 0.5 to 8 wt %; more preferably, 1 to 7.5 wt %; most preferably, 2 to 7 wt %), based on weight of the laundry treatment formulation, of an esterquat; wherein the esterquat is a compound comprising a cationic nitrogen (N⁺) atom, at least one fatty carbon chain containing 4 to 36 carbon atoms, and at least one ester function. The fatty carbon chain may optionally comprise hetero atoms other than carbon atoms (e.g., Si atoms). The cationic nitrogen atom may be linked to the at least one fatty carbon chain via ester functions, for example via: —(CH₂)ₐ—O—C(═O)— chains in which a is 0 to 5 and/or =C(—O—C(═O)—(CH₂)_{b}—CH₃)₂ in which b is 4 to 36. Various types of esterquats may be suitable for use in the laundry treatment formulations of the present invention, including, for example, monoesterquats (EQ), triester-quaternary ammonium compounds (TEQ) and diester-quaternary ammonium compounds (DEQ). These compounds may also comprises a mixture of mono-(I), di-(II) and tri-(III) ester components. Preferably, the esterquat is a partially hydrogenated palm esterquat.

Preferably, the laundry treatment formulation of the present invention is a laundry refresher formulation comprising: 25 to 97.8 wt %, based on weight of the laundry refresher formulation, of a liquid carrier; and, 2 to 60 wt %, based on weight of the laundry refresher formulation, of a cleaning surfactant; 0.1 to 10 wt %, based on weight of the laundry refresher formulation, of an esterquat; and 0.1 to 10 wt %, based on weight of the laundry refresher formulation, of the modified carbohydrate polymer. More preferably, the laundry treatment formulation of the present invention is a laundry refresher formulation comprising: 25 to 97.8 wt %, based on weight of the laundry refresher formulation, of a liquid carrier; 2 to 60 wt %, based on weight of the laundry refresher formulation, of a cleaning surfactant; 0.1 to 10 wt %, based on weight of the laundry refresher formulation, of an esterquat; and 0.1 to 10 wt %, based on weight of the laundry refresher formulation, of the modified carbohydrate polymer; wherein the liquid carrier comprises water and wherein >20 wt % (preferably, >25 wt %; more preferably, >30 wt %; most preferably, >40 wt %), based on weight of the laundry refresher formulation, of water.

Preferably, the laundry treatment formulation of the present invention contains <0.01 wt % (preferably, <0.001 wt %; more preferably, <0.0001 wt %; most preferably, <the detectable limit), based on weight of the laundry treatment formulation, of carboxymethyl cellulose.

Preferably, the laundry treatment formulation of the present invention contains <0.01 wt % (preferably, <0.001 wt %; more preferably, <0.0001 wt %; most preferably, <the detectable limit), based on weight of the laundry treatment formulation, of hydrophobically carboxymethyl cellulose.

Preferably, the laundry treatment formulation of the present invention contains <0.1 wt % (preferably, <0.01 wt %; more preferably, <0.0001 wt %; most preferably, <the detectable limit), based on weight of the laundry treatment formulation, of cationic hydroxyethylcellulose polymer.

Preferably, the laundry treatment formulation of the present invention contains <0.2 wt % (preferably, <0.01 wt %; more preferably, <0.001 wt %; most preferably, <the detectable limit), based on weight of the laundry treatment formulation, of a fatty acid or fatty acid salt according to the formula

R¹¹COOM

wherein R¹¹ is a primary or secondary alkyl group of 4 to 30 carbon atoms and wherein M is a hydrogen cation or another solubilizing cation (e.g., alkali metals cations such as sodium and potassium; and amines such as triethanolammonium, ammonium and morpholinium).

Preferably, the laundry treatment formulation of the present invention, optionally further comprises a hydrotrope. More preferably, the laundry treatment formulation of the present invention, optionally further comprises: 0 to 10 wt % (preferably, 0.1 to 7.5 wt %; more preferably, 0.2 to 5 wt %; most preferably, 0.5 to 2.5 wt %), based on the weight of the laundry treatment formulation, of a hydrotrope. More preferably, the laundry treatment formulation of the present invention, optionally further comprises: 0 to 10 wt % (preferably, 0.1 to 7.5 wt %; more preferably, 0.2 to 5 wt %; most preferably, 0.5 to 2.5 wt %), based on the weight of the laundry treatment formulation, of a hydrotrope; wherein the hydrotrope is selected from the group consisting of calcium, sodium, potassium, ammonium and alkanol ammonium salts of xylene sulfonic acid, toluene sulfonic acid, ethylbenzene sulfonic acid, naphthalene sulfonic acid and cumene sulfonic acid; salts thereof and mixtures thereof. Most preferably, the laundry treatment formulation of the present invention, further comprises: 0 to 10 wt % (preferably, 0.1 to 7.5 wt %; more preferably, 0.2 to 5 wt %; most preferably, 0.5 to 2.5 wt %), based on the weight of the laundry treatment formulation, of a hydrotrope; wherein the hydrotrope is selected from the group consisting of sodium toluene sulfonate, potassium toluene sulfonate, sodium xylene sulfonate, ammonium xylene sulfonate, potassium xylene sulfonate, calcium xylene sulfonate, sodium cumene sulfonate, ammonium cumene sulfonate and mixtures thereof.

Preferably, the laundry treatment formulation of the present invention, optionally further comprises a fragrance. More preferably, the laundry treatment formulation of the present invention, optionally further comprises: 0 to 10 wt % (preferably, 0.001 to 5 wt %; more preferably, 0.005 to 3 wt %; most preferably, 0.01 to 2.5 wt %), based on the weight of the laundry treatment formulation, of a fragrance.

Preferably, the laundry treatment formulation of the present invention, optionally further comprises a builder. More preferably, the laundry treatment formulation of the present invention, optionally further comprises: 0 to 50 wt % (preferably, 5 to 50 wt %; more preferably, 7.5 to 30 wt %), based on the weight of the laundry treatment formulation, of a builder. Most preferably, the laundry treatment formulation of the present invention, optionally further comprises: 0 to 50 wt % (preferably, 5 to 50 wt %; more preferably, 7.5 to 30 wt %), based on the weight of the laundry treatment formulation, of a builder; wherein the builder; wherein the builder is selected from the group consisting of inorganic builders (e.g., tripolyphosphate, pyrophosphate); alkali metal carbonates; borates; bicarbonates; hydroxides; zeolites; citrates (e.g., sodium citrate); polycarboxylates; monocarboxylates; aminotrismethylenephosphonic acid; salts of aminotrismethylenephosphonic acid; hydroxyethanediphosphonic acid; salts of hydroxyethanediphosphonic acid; diethylenetriaminepenta(methylenephosphonic acid); salts of diethylenetriaminepenta(methylenephosphonic acid); ethylenediaminetetraethylene-phosphonic acid; salts of ethylenediaminetetraethylene-phosphonic acid; oligomeric phosphonates; polymeric phosphonates; mixtures thereof.

Preferably, the laundry treatment formulation of the present invention, optionally further comprises a pH adjusting agent. More preferably, the laundry treatment formulation of the present invention, optionally further comprises a pH adjusting agent; wherein the laundry treatment formulation has a pH from 6 to 12.5 (preferably, 6.5 to 11; more preferably, 7.5 to 10). Bases for adjusting pH include mineral bases such as sodium hydroxide (including soda ash) and potassium hydroxide; sodium bicarbonate; sodium silicate; ammonium hydroxide; and organic bases (e.g., mono-, di- or tri-ethanolamine; 2-dimethylamino-2-methyl-1-propanol (DMAMP); monoisopropanolamine (MIPA); diisopropanolamine (DIPA); triisopropanolamine (TIPA)). Acids to adjust the pH include mineral acids (e.g., hydrochloric acid, phosphorus acid and sulfuric acid) and organic acids (e.g., acetic acid).

The laundry treatment formulation of the present invention may be provided in a format selected from the group consisting of a dry powder formulation; a granulated powder formulation; a nonaqueous (<10 wt %; more preferably, <7 wt % water) liquid formulation; an aqueous liquid formulation; a nonwoven fabric sheets infused with the laundry treatment formulation for addition to laundry or dryer; polymer beads encapsulating or infused with the laundry treatment formulation; and a unit dose article comprising the laundry treatment formulation encapsulated in a water soluble film (both single compartment unit dose articles and multicompartment unit dose articles).

Preferably, the laundry treatment formulation of the present invention, optionally further comprises a water soluble film; wherein the laundry detergent formulation is encapsulated by the water soluble film. More preferably, the laundry treatment formulation of the present invention, optionally further comprises a water soluble film, wherein the water soluble film has a disintegration time of less than 90 seconds as determined at 40° C. using distilled water according to MSTM 205 when measured independently from the laundry treatment formulation; and wherein the laundry detergent formulation is encapsulated by the water soluble film. Still more preferably, the laundry treatment formulation of the present invention, optionally further comprises a water soluble film, wherein the water soluble film has a disintegration time of less than 90 (preferably, less than 60; more preferably, less than 40; most preferably, less than 30) seconds as determined at 40° C. (preferably, at 30° C.; more preferably, at 25° C.; most preferably, at 21° C.) using distilled water according to MSTM 205 when measured independently from the laundry treatment formulation; and wherein the laundry detergent formulation is encapsulated by the water soluble film. Most preferably, the laundry detergent formulation of the present invention, optionally further comprises a water soluble film, wherein the water soluble film has a disintegration time of less than 90 (preferably, less than 60; more preferably, less than 40; most preferably, less than 30) seconds as determined at 40° C. (preferably, at 30° C.; more preferably, at 25° C.; most preferably, at 21° C.) using distilled water according to MSTM 205 when measured independently from the laundry treatment formulation; and wherein the water soluble film comprises (consists essential of, or consists of) a material selected from the group consisting of polyvinyl alcohol, polyvinyl acetate, hydrolyzed polyvinyl acetate (preferably, polyvinyl acetate that is 88 to 98% hydrolyzed), gelatin and combinations thereof; and wherein the laundry detergent formulation is encapsulated by the water soluble film. Preferably, the water soluble film includes polyvinyl alcohol. Such water soluble films include, for example, those commercially available from Monosol under trade names A127, A200, L330, L336, L336 Blue, L711, L711 Blue, M1030, M1030, M2000, M2631A, M3030, M6030, M7030, M7031, M7061, M8310, M8440, M8534, M8630, M8900 and M9500. Preferably, the laundry detergent formulation of the present invention, optionally further comprises a water soluble film; wherein the water soluble film encapsulates the laundry detergent formulation to form a unit dose article, comprising: a single layer or multiple layers of the water soluble film. Preferably, each water soluble film layer has a thickness of 5 to 200 (preferably, 5 to 100; more preferably, 20 to 85; still more preferably, 30 to 70; most preferably, 40 to 60) microns.

Preferably, the method of treating a fabric article of the present invention, comprises: providing a soiled fabric article (preferably, wherein the soiled fabric article is soiled with at least one of sebum, carbon black, grass and mud, dirty motor oil, tomato puree, chocolate drink, clay, dry ink, spaghetti sauce and lard; more preferably, wherein the soiled fabric article is soiled with at least one of sebum, carbon black and dirty motor oil; most preferably, wherein the soiled fabric article is soiled with sebum and carbon black)(preferably, wherein the soiled fabric article is selected from the group consisting of stained cotton, stained polyester cotton blend and stained knitted cotton; more preferably, wherein the soiled fabric article is cotton or polyester cotton blend stained with sebum and carbon black); providing a laundry treatment formulation of the present invention; providing a wash water; and applying the wash water and the laundry treatment formulation to the soiled fabric to provide a cleaned fabric article. More preferably, the method of treating a fabric article of the present invention, comprises: providing a soiled fabric article (preferably, wherein the soiled fabric article is soiled with at least one of sebum, carbon black, grass and mud, dirty motor oil, tomato puree, chocolate drink, clay, dry ink, spaghetti sauce and lard; more preferably, wherein the soiled fabric article is soiled with at least one of sebum, carbon black and dirty motor oil; most preferably, wherein the soiled fabric article is soiled with sebum and carbon black)(preferably, wherein the soiled fabric article is selected from the group consisting of stained cotton, stained polyester cotton blend and stained knitted cotton; more preferably, wherein the soiled fabric article is cotton or polyester cotton blend stained with sebum and carbon black); providing a laundry treatment formulation of the present invention; providing a wash water; providing a rinse water; applying the wash water and the laundry treatment formulation to the soiled fabric to provide a cleaned fabric article; and then applying the rinse water to the cleaned fabric article to remove the laundry detergent formulation from the cleaned fabric article.

Some embodiments of the present invention will now be described in detail in the following Examples.

### Synthesis S1: Hydrophobically Modified Cellulose Ether Base Material

A 500 mL, four-necked, round-bottomed flask was charged with 27.31 g (25.00 g contained) of cellulose ether base material (CELLOSIZE™ HEC QP-52000H hydroxyethyl cellulose with a weight average molecular weight, M_{W}, of 1,400,000 Daltons available from The Dow Chemical Company) and 125.46 g of isopropyl alcohol with 16.94 g of deionized water. The flask was fitted with a nitrogen inlet connected to a 60 mL pressure-equalizing addition funnel, rubber septum cap, a stirring paddle connected to an electric motor, and a Claisen adaptor connected to a Friedrich condenser with a mineral oil bubbler outlet. The addition funnel was charged with 2.47 g of HAGE 16 with 7.20 g of isopropyl alcohol. While stirring the slurry, the head space of the flask was purged with a slow, steady flow of nitrogen for one hour to remove any entrained oxygen in the apparatus. A flow rate of approximately one bubble per second was sufficient. While stirring under nitrogen, 1.60 g of 50% aqueous sodium hydroxide solution was added dropwise using a plastic syringe over 2 minutes. After stirring for one hour, hexadecyl glycidyl ether (HAGE 16) was added dropwise via the addition funnel over 3 minutes. The solution was stirred under nitrogen for 20 minutes, and then heat was applied using a heating mantle. While stirring under nitrogen, the solution was heated to reflux and held for 4.5 hours. The slurry was then cooled in an ice water bath while maintaining a positive nitrogen pressure in the flask. The slurry was neutralized by adding 2.16 g glacial acetic acid using a syringe, and the resulting slurry was stirred for 10 minutes under nitrogen. The polymer was recovered by vacuum filtration through a large fritted metal Buchner funnel. The filter cake was washed in the Buchner funnel by stirring the slurry in the funnel for 5 minutes with the specified wash solvent followed by vacuum removal of the wash liquor: 36 g water in 164 g isopropyl alcohol, 20 g water in 180 g isopropyl alcohol, and 200 g isopropyl alcohol for desiccation. To confer cold-water dispersibility on the final polymer, 0.44 g of 40% aqueous glyoxal and 0.15 g acetic acid were added to the final desiccation wash. The polymer was recovered by vacuum filtration, briefly air-dried, and dried overnight in vacuo at 50° C.

### Synthesis S2: Modified Carbohydrate Polymer

A 500 mL, four-necked, round-bottomed flask was charged with 22.55 g (19.59 g contained) of the product of Synthesis S1 and 168.48 g of isopropyl alcohol with 30.13 g of deionized water. The flask was fitted with a nitrogen inlet connected to a 60 mL pressure-equalizing addition funnel, rubber septum cap, a stirring paddle connected to an electric motor, and a Claisen adaptor connected to a Friedrich condenser with a mineral oil bubbler outlet. The addition funnel was charged with 15.12 g of QUAB 151. While stirring the slurry, the head space of the flask was purged with a slow, steady flow of nitrogen for one hour to remove any entrained oxygen in the apparatus. A flow rate of approximately one bubble per second was sufficient. While stirring under nitrogen, 2.40 g of 25% aqueous sodium hydroxide solution was added dropwise using a plastic syringe over 2 minutes. After stirring for one hour, the QUAB 151 was added dropwise via the addition funnel over 3 minutes. The solution was stirred under nitrogen for 20 minutes, and then heat was applied using a heating mantle. While stirring under nitrogen, the solution was heated to 55° C. and held for 1.5 hours. The slurry was then cooled in an ice water bath while maintaining a positive nitrogen pressure in the flask. The slurry was neutralized by adding 2.50 g glacial acetic acid using a syringe, and the resulting slurry was stirred for 10 minutes under nitrogen. The polymer was recovered by vacuum filtration through a large fritted metal Buchner funnel. The filter cake was washed in the Buchner funnel by stirring the slurry in the funnel for 5 minutes with the specified wash solvent followed by vacuum removal of the wash liquor: 36 g water in 164 g isopropyl alcohol, 20 g water in 180 g isopropyl alcohol, and 200 g isopropyl alcohol for desiccation. To confer cold-water dispersibility on the final polymer, 0.44 g of 40% aqueous glyoxal and 0.15 g acetic acid were added to the final desiccation wash. The polymer was recovered by vacuum filtration, briefly air-dried, and dried overnight in vacuo at 50° C. The product cationic hmHEC polymer had a volatiles content of 3.77 wt %, an ash content of 2.41 wt % (as sodium chloride) and a Kjeldahl nitrogen content of 1.76 wt %. The 1% solution viscosity (corrected for ash and volatiles) was measured at 6.31 sec-1 using a TA Instruments DHR-3 rheometer equipped with a 40 mm, 2.0° stainless steel cone & plate sensor at 25.0° C. and was found to be 6,268 mPa s.

### Comparative Example C1 and Examples 1-5: Liquid Treatment Formulations

The laundry treatment formulations used in the fabric treating tests in the subsequent Examples were prepared having the formulations as described in TABLE 1 and were prepared by standard laundry treatment formulation preparation procedures.

TABLE 1

| | Example (in wt %) | | | | | | |
|---|---|---|---|---|---|---|---|
| Ingredient | C1 | C2 | 1 | 2 | 3 | 4 | 5 |
| Propylene glycol | q.s. 100 | | | | | | |
| Linear alkyl benzene | 12.24 | 12.18 | 12.08 | 12.18 | 12.12 | 11.47 | 12.21 |
| sulfonate¹ | | | | | | | |
| Sodium lauryl | 20.62 | 20.51 | 20.35 | 20.51 | 20.41 | 19.32 | 20.56 |
| ethoxysulfate² | | | | | | | |
| Ethylene glycol | 4.12 | 4.10 | 4.07 | 4.10 | 4.08 | 3.86 | 4.11 |
| monohexyl ether³ | | | | | | | |
| Glycerin | 1.13 | 1.12 | 1.11 | 1.12 | 1.11 | 1.05 | 1.12 |
| Nonionic alcohol | 26.75 | 26.62 | 26.40 | 26.62 | 26.48 | 25.06 | 26.67 |
| ethoxylate surfactant⁴ | | | | | | | |
| Seconday alcohol | 10.32 | 10.27 | 10.19 | 10.27 | 10.22 | 9.67 | 10.29 |
| ethoxylate surfactant⁵ | | | | | | | |
| Fluoresent whitening | 0.10 | 0.10 | 0.10 | 0.10 | 0.10 | 0.09 | 0.10 |
| agent⁶ | | | | | | | |
| Monoethanolamine | 2.57 | 2.56 | 2.54 | 2.56 | 2.55 | 2.41 | 2.57 |
| (MEA)⁷ | | | | | | | |
| Antifoam⁸ | 0.35 | 0.35 | 0.35 | 0.35 | 0.35 | 0.33 | 0.35 |
| Enzymes⁹ | 1.69 | 1.68 | 1.67 | 1.68 | 1.67 | 1.58 | 1.68 |
| Perfume¹⁰ | 1.55 | 1.54 | 1.53 | 1.54 | 1.53 | 1.45 | 1.54 |
| Silicone Emulsion¹¹ | — | — | 1.00 | — | — | — | — |
| Esterquat¹² | — | — | — | — | — | 6.00 | — |
| Conditioning | — | 0.5 | — | — | — | — | — |
| polymer¹³ | | | | | | | |
| Synthesis S2 | — | — | 0.30 | 0.50 | 1.00 | 0.30 | 0.30 |

¹Nansa HS80/S available from Alfa Chemicals
²Lutensol N70 (70 wt % solution in water) available from BASF
³Hexyl CELLOSOLVE ™ solvent available from The Dow Chemical Company
⁴Tergitol ™ N25-7 available from The Dow Chemical Company
⁵Tergitol ™ 15-S-9 available from The Dow Chemical Company
⁶Tinopal CBSX available from BASF
⁷available from The Dow Chemical Company
⁸DowSil ™ AF-8017 available from The Dow Chemical Company
⁹Medley Brilliant 300 L available from Novozymes
¹⁰Perfume Powder dose 90 abailable from Givaudan
¹¹DowSil ™ HV496 available from The Dow Chemical Company
¹²Tetranyl L6/90 available from Kao
¹³SupraCare ™ 133 polymer available from The Dow Chemical Company

Fabric Softness

Refreshing softness performance of the laundry treatment formulations of Comparative Example C1 and Examples 1-3 were assessed in a Miele W377 with Program set to cotton/40° C./600 rpm (72 min). Twenty-five grams of the laundry treatment formulation was used for each test. Soft water was used. Fabric articles treated in each test consisted of five cotton pillow cases and 4 small terry cotton towels (30 cm×50 cm). The treated fabric articles were washed 3 times, line dried overnight and then evaluated by 5 panelists who ranked the softness—higher numbers correspond with softer fabrics. The results are proved in TABLE 2.

TABLE 2

| Laundry Treatment Formulation | Rank |
|---|---|
| Comparative Example C1 | 7 |
| Example 1 | 10 |
| Example 2 | 15 |
| Example 3 | 18 |

### Fabric Softness

Refreshing softness performance of the laundry treatment formulations of Comparative Example C2 and Examples 4-5 were assessed in a Miele W377 with Program set to cotton/40° C./600 rpm (72 min). Fifty grams of the laundry treatment formulation was used for each test. The water hardness was 16° French Hardness, Ca/Mg 4/1 ratio with 11 liters of wash water per wash. Fabric articles treated in each test consisted of five cotton pillow cases and 4 small terry cotton towels (30 cm×50 cm). The treated fabric articles were washed 3 times, line dried overnight and then evaluated by 5 panelists who ranked the softness—higher numbers correspond with softer fabrics. The results are proved in TABLE 3.

TABLE 3

| Laundry Treatment Formulation | Rank |
|---|---|
| Commercial Offering¹ | 6 |
| Example 4 | 10 |
| Example 5 | 8 |

¹Dash & Lenor 3-in-1 detergent pod available from Procter & Gamble

### Anti-Redeposition

The anti-redeposition performance of the laundry treatment formulations of Comparative Example C2 and Example 2 were assessed in in a Miele W1614 with Program set to cotton/40° C./1,000 rpm (124 min) Each load took 10-11 liters of wash water with 25° French Hardness and 23 TAC. The soils used were 4 SBL 2004. Each load of laundry comprised 6 pillow cases, 5 huckaback towels and 1 bed sheet. Each load was prewashed (3 cycles) before testing. White swatches are placed in with the laundry load: 2 cotton fabrics WFK10A, 2 polyester/cotton blend WFK20A and 2 polyester fabrics WFK30A. The fabrics were washed six times in a six machine rotation. After each wash cycle, the machines were cleaned emty using an Express program (30 min) at 40° C./800 rpm. The white swatches in each laundry batch following the sixth laundry cycle were then measured with a MACH 5⁺ instrument. The whiteness index for the neat unwashed fabrics was used as the positive control. The change in the whiteness index relative to the positive control for each of the laundry treatment formulations are provided in TABLE 4.

TABLE 4

Delta in Whiteness
Index

| Example | CT | C |
|---|---|---|
| Comp. Ex. C2 | 8.80 | 4.70 |
| Ex. 2 | 6.75 | 4.41 |

### Examples 6-8: Liquid Treatment Formulations

The laundry treatment formulations used in the fabric treating tests in the subsequent Examples were prepared having the formulations as described in TABLE 5 and were prepared by standard laundry treatment formulation preparation procedures.

TABLE 5

Example (in wt %)

| Ingredient | 6 | 7 | 8 |
|---|---|---|---|
| Seconday alcohol ethoxylate surfactant¹ | 10.1 | 10.1 | 10.1 |
| Cocamidopropyl betaine² | 9.08 | 9.08 | 9.08 |
| Glycol ether³ | 0.53 | 0.53 | 0.53 |
| Esterquat⁴ | 50.01 | 50.01 | 25 |
| Synthesis S2 | 0.3 | — | 0.3 |

| | |
|---|---|
| Deionized water | q.s. 100 |

¹Tergitol ™ 15-S-9 available from The Dow Chemical Company
²Mackan C-37 HP available from Solvay Novecare
³Dowanol ™ EPH available from The Dow Chemical Company
⁴Tetranyl L6/90 available from Kao 12 wt % solution in water

### Fabric Softness

Refreshing softness performance of the laundry treatment formulations of Examples 6-8 were assessed in a Miele W377 with Program set to cotton/40° C./600 rpm (72 min). Fifty grams of the laundry treatment formulation was used for each test. The water hardness was 16° French Hardness, Ca/Mg 4/1 ratio with 11 liters of wash water per wash. Fabric articles treated in each test consisted of five cotton pillow cases and 4 small terry cotton towels (30 cm×50 cm). The treated fabric articles were washed 3 times, line dried overnight and then evaluated by 5 panelists who ranked the softness—higher numbers correspond with softer fabrics. The treated fabric articles were then evaluated by 5 panelists who ranked the softness—higher numbers correspond with softer fabrics. The results are proved in TABLE 6.

TABLE 6

| Laundry Treatment Formulation | Rank |
|---|---|
| Example 6 | 16 |
| Example 7 | 9 |
| Example 8 | 11 |

### Comparative Examples C3-C4 and Examples 9-10: Liquid Treatment Formulations

The laundry treatment formulations used in the fabric treating tests in the subsequent Examples were prepared having the formulations as described in TABLE 7 and were prepared by standard laundry treatment formulation preparation procedures.

TABLE 7

| | Example (in wt %) | | | |
|---|---|---|---|---|
| Ingredient | C3 | C4 | 9 | 10 |
| Propylene glycol | q.s. 100 | | | |
| Linear alkyl benzene sulfonate¹ | 10.56 | 10.50 | 10.50 | 10.56 |
| Sodium lauryl ethoxysulfate² | 17.90 | 17.81 | 17.81 | 17.90 |
| Ethylene glycol monohexyl ether³ | 3.58 | 3.56 | 3.56 | 3.58 |
| Glycerin | 0.98 | 0.98 | 0.98 | 0.98 |
| Nonionic alcohol ethoxylate surfactant⁴ | 23.44 | 23.33 | 23.33 | 23.44 |
| Seconday alcohol ethoxylate surfactant⁵ | 8.95 | 8.90 | 8.90 | 8.95 |
| Fluoresent whitening agent⁶ | 0.09 | 0.09 | 0.09 | 0.09 |
| Monoethanolamine⁷ | 2.24 | 2.23 | 2.23 | 2.24 |
| Antifoam⁸ | 2.87 | 2.85 | 2.85 | 2.87 |
| Protease⁹ | 2.15 | 2.14 | 2.14 | 2.15 |
| Amylase¹⁰ | 0.45 | 0.44 | 0.44 | 0.45 |
| Mannase¹¹ | 0.35 | 0.35 | 0.35 | 0.35 |
| Cellulase¹² | 0.09 | 0.09 | 0.09 | 0.09 |
| Perfume¹³ | 1.26 | 1.25 | 1.25 | 1.26 |
| Esterquat¹⁴ | 9.0 | 9.0 | 9.0 | — |
| Conditioning polymer¹⁵ | — | 0.90 | — | — |
| Synthesis S2 | — | — | 0.45 | 0.45 |

¹Nansa HS80/S available from Alfa Chemicals
²Lutensol N70 (70 wt % solution in water) available from BASF
³Hexyl CELLOSOLVE ™ solvent available from The Dow Chemical Company
⁴Tergitol ™ N25-7 available from The Dow Chemical Company
⁵Tergitol ™ 15-S-9 available from The Dow Chemical Company
⁶Tinopal CBSX available from BASF
⁷available from The Dow Chemical Company
⁸DowSil ™ DB310 available from The Dow Chemical Company
⁹Preferenz P300 available from Essential Ingredients
¹⁰Preferenz S210 available from Essential Ingredients
¹¹Preferenz M100 available from Essential Ingredients
¹²Revitalenz 200 available from Essential Ingredients
¹³Perfume Powder dose 90 abailable from Givaudan
¹⁴Tetranyl L6/90 available from Kao
¹⁵SupraCare ™ 133 polymer available from The Dow Chemical Company

### Primary Cleaning Performance Test

The primary cleaning performance of the laundry treatment formulations of Comparative Examples C3-C6 and Examples 6 and 9-10 were assessed in a Miele W1614 with Program set to cotton/40° C./1,000 rpm (124 min.). Each load took 10-11 liters of wash water with 25° French Hardness and 23 TAC. The soils used were 4 SBL 2004. Each load of laundry comprised 6 pillow cases, 5 huckaback towels and 1 bed sheet. Each load was prewashed (3 cycles) before testing. The stain fabrics (one with eleven stains—sebum with carbon black on Cotton; sebum with carbon black on polyester/cotton blend, grass/mud on polyester/cotton blend, dirty motor oil, tomato puree, chocolate drink on cotton, standard clay on cotton, red pottery clay on cotton, dry ink on cotton, spaghetti sauce and lard)(one with three stains—grass, balsamic salad dressing, and potato starch) were sewn onto a monitor placed in with the laundry load. Both of the monitors with stains were dried on drying line overnight. The stains were measured with a MACH 5+ instrument (L, a & b). The results are noted in TABLE 8, wherein ΔE* is according to the equation

ΔE*=ΔE_{aw}−ΔE_{bw}

wherein ΔE_{aw} is measured from fabrics after washing, and ΔE_{bw} is measured from fabrics before washing. A higher ΔE* corresponds with better primary cleaning performance

TABLE 8

| Formulation | Fabric | Stain | ΔE* |
|---|---|---|---|
| Comp. Ex. C3 | Cotton | Sebum with carbon black | 15.77 |
| | | Chocolate drink | 8.16 |
| | | Standard clay | 7.18 |
| | | Red potter clay | 14.09 |
| | | Dry ink | 29.51 |
| | | Spaghetti sauce | 23.49 |
| | | Lard | 39.25 |
| | | Grass | 23.77 |
| | | Balsamic salad dressing | 28.20 |
| | | Potato starch | 43.72 |
| | Poly/cotton blend | Sebum with carbon black | 17.81 |
| | | Grass/mud | 13.69 |
| | Knit cotton | Dirty motor oil | 15.80 |
| | | Tomato puree | 25.53 |
| Comp. Ex. C4 | Cotton | Sebum with carbon black | 15.92 |
| | | Chocolate drink | 7.86 |
| | | Standard clay | 6.24 |
| | | Red potter clay | 12.64 |
| | | Dry ink | 28.33 |
| | | Spaghetti sauce | 22.99 |
| | | Lard | 38.12 |
| | | Grass | 22.92 |
| | | Balsamic salad dressing | 26.09 |
| | | Potato starch | 43.32 |
| | Poly/cotton blend | Sebum with carbon black | 16.81 |
| | | Grass/mud | 12.75 |
| | Knit cotton | Dirty motor oil | 15.27 |
| | | Tomato puree | 24.90 |
| Comp. Ex. C5 | Cotton | Sebum with carbon black | 14.88 |
| Ariel Lenor | | Chocolate drink | 8.85 |
| POD available | | Standard clay | 11.46 |
| from Procter & | | Red potter clay | 20.19 |
| Gample | | Dry ink | 24.99 |
| | | Spaghetti sauce | 25.59 |
| | | Lard | 35.92 |
| | Poly/cotton blend | Sebum with carbon black | 18.51 |
| | | Grass/mud | 17.80 |
| | Knit cotton | Dirty motor oil | 16.36 |
| | | Tomato puree | 27.20 |
| Comp. Ex. C6 | Cotton | Sebum with carbon black | 13.7 |
| Lovable | | Chocolate drink | 6.42 |
| available from | | Standard clay | 5.3 |
| Henkel | | Red potter clay | 11.8 |
| | | Dry ink | 19.47 |
| | | Spaghetti sauce | 21.85 |
| | | Lard | 28.78 |
| | Poly/cotton blend | Sebum with carbon black | 14.59 |
| | | Grass/mud | 11.06 |
| | Knit cotton | Dirty motor oil | 13.1 |
| | | Tomato puree | 23.32 |
| Example 6 | Cotton | Sebum with carbon black | 4.54 |
| | | Chocolate drink | 4.41 |
| | | Standard clay | 3.58 |
| | | Red potter clay | 11.57 |
| | | Dry ink | 25.00 |
| | | Spaghetti sauce | 20.68 |
| | | Lard | 24.92 |
| | | Grass | 11.48 |
| | | Balsamic salad dressing | 13.63 |
| | | Potato starch | 37.39 |
| | Poly/cotton blend | Sebum with carbon black | 1.64 |
| | | Grass/mud | 9.78 |
| | Knit cotton | Dirty motor oil | 7.66 |
| | | Tomato puree | 23.24 |
| Example 9 | Cotton | Sebum with carbon black | 15.71 |
| | | Chocolate drink | 7.59 |
| | | Standard clay | 6.52 |
| | | Red potter clay | 13.80 |
| | | Dry ink | 28.92 |
| | | Spaghetti sauce | 22.93 |
| | | Lard | 39.38 |
| | | Grass | 23.12 |
| | | Balsamic salad dressing | 26.89 |
| | | Potato starch | 43.37 |
| | Poly/cotton blend | Sebum with carbon black | 18.54 |
| | | Grass/mud | 13.33 |
| | Knit cotton | Dirty motor oil | 15.37 |
| | | Tomato puree | 25.13 |
| Example 10 | Cotton | Sebum with carbon black | 15.41 |
| | | Chocolate drink | 7.69 |
| | | Standard clay | 6.66 |
| | | Red potter clay | 13.82 |
| | | Dry ink | 28.47 |
| | | Spaghetti sauce | 23.15 |
| | | Lard | 37.35 |
| | | Grass | 24.29 |
| | | Balsamic salad dressing | 27.58 |
| | | Potato starch | 43.54 |
| | Poly/cotton blend | Sebum with carbon black | 17.66 |
| | | Grass/mud | 13.28 |
| | Knit cotton | Dirty motor oil | 15.29 |
| | | Tomato puree | 25.26 |

### Comparative Example C7 and Example 11: Liquid Treatment Formulations

The laundry treatment formulations used in the subsequent color protection tests were prepared having the formulations as described in TABLE 9 and were prepared by standard laundry treatment formulation preparation procedures.

TABLE 9

Example (in wt %)

| Ingredient | C7 | 11 |
|---|---|---|
| Whitening agent¹ | 0.11 | 0.10 |
| Nonionic alcohol ethoxylate surfactant² | 10.03 | 10.03 |
| Esterquat³ | 49.91 | 49.65 |
| Synthesis S2 | — | 0.31 |
| Preservative⁴ | 0.53 | 0.73 |

| | |
|---|---|
| Deionized water | q.s. 100 |

¹Tinopal CBSX fluorescent whitening agent available from BASF
²EcoSurf ™ EH-6 surfactant available from The Dow Chemical Company
³Tetranyl L6/90 available from Kao 12 wt % solution in water
⁴Neolone preservative available from DuPont

### Color Protection

Color protection performance of the laundry treatment formulations of Comparative Example C7 and Example 11 were assessed in a Miele W1915 with Program set to cotton/40° C./1000 rpm (72 min). Fifty grams of the laundry treatment formulation was used for each test. The water hardness was 16° French Hardness, Ca/Mg 4/1 ratio. Water quantity is automatically taken from the machine, about 11 liters of wash water per wash. The soils used were 2 SBL 2004. Each load of laundry comprised 15 pillow cases. Fabric articles treated in each test consisted of color fabrics supplied by Center for Testmaterials b.v. The treated fabric articles were washed 3 times, line dried overnight and then evaluated for color intensity L* measured using MACH 5⁺. The results are proved in TABLE 10.

TABLE 10

| | L* value | | |
|---|---|---|---|
| | AISE-01-007A | AISE-08-008F | AISE-33-006 |
| Formulation | Black Sulphur Cotton | Yellow Direct Cotton | Blue Polyester |
| (initial no wash) | 22.1 | 81.8 | 16.2 |
| Comp. Ex. C7 | 14.7 | 80.1 | 12 |
| Example 11 | 23.8 | 82.2 | 13.9 |

We claim:

1. A laundry treatment formulation comprising:
a modified carbohydrate polymer, wherein the modified carbohydrate polymer comprises a cellulose ether base material functionalized with (i) trialkyl ammonium moieties of formula (I) 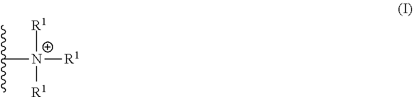
wherein each R¹ is independently selected from the group consisting of a C₁₋₇ alkyl group and wherein the modified carbohydrate polymer has a Kjeldahl nitrogen content, TKN, corrected for ash and volatiles, of 0.75 to 2.5 wt %; and (ii) hydrophobic substituents each having 16 carbon atoms; wherein the modified carbohydrate polymer comprises 0.005 to 1.5 wt %, based on weight of the cellulose ether base material, of the hydrophobic substituents; wherein the hydrophobic substituents are randomly distributed across the backbone of the cellulose ether base material; wherein the cellulose ether base material has a weight average molecular weight, M_{W}, of >800,000 Daltons.

2. The laundry treatment formulation of claim 1, wherein the modified carbohydrate polymer is of formula (III) 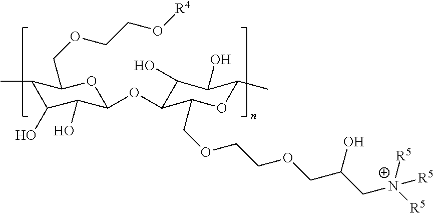
wherein n is determined based on the weight average molecular weight, M_{W}, of the cellulose ether base material; wherein R⁴ is an alkyl group having 16 carbon atoms and wherein each R⁵ is independently selected from the group consisting of a methyl group.

3. The laundry treatment formulation of claim 2, further comprising:
25 to 97.9 wt %, based on weight of the laundry treatment formulation, of a liquid carrier; and, 2 to 60 wt %, based on weight of the laundry treatment formulation, of a cleaning surfactant; and
0.1 to 10 wt %, based on weight of the laundry treatment formulation, of the modified carbohydrate polymer wherein the laundry treatment formulation is a laundry detergent formulation.

4. The laundry treatment formulation of claim 3, wherein the liquid carrier comprises water and wherein >20 wt %, based on weight of the laundry detergent formulation, is water.

5. The laundry treatment formulation of claim 4, wherein the liquid carrier further comprises a mixture of propylene glycol, ethylene glycol monohexyl ether, and glycerin.

6. The laundry treatment formulation of claim 5, wherein the hydrophobic substituent is bonded to the cellulose ether base material through (a) an ether linkage or (b) an ether linkage and a 2-hydroxypropyl group.

7. The laundry treatment formulation of claim 6, wherein the laundry detergent formulation, further comprises at least one of a structurant, a hydrotrope, a fragrance, a builder and a fabric softener.

8. The laundry treatment formulation of claim 3, wherein the laundry treatment formulation, further comprises an esterquat.

9. A method of treating a fabric article, comprising:
providing a soiled fabric article;
providing a laundry treatment formulation of claim 7;
providing a wash water; and
applying the wash water and the laundry treatment formulation to the soiled fabric to provide a cleaned fabric article.

10. A method of treating a fabric article, comprising:
providing a soiled fabric article;
providing a laundry treatment formulation of claim 8;
providing a wash water; and
applying the wash water and the laundry treatment formulation to the soiled fabric to provide a cleaned fabric article.
